(19) United States
(12) Patent Application Publication
(10) Pub. No.: US 2024/0210611 A1
(43) Pub. Date: Jun. 27, 2024

(54) LIGHTGUIDE WITH POLARIZATION-SELECTIVE BULK REFLECTORS

(71) Applicant: Meta Platforms Technologies, LLC, Menlo Park, CA (US)

(72) Inventors: Miaomiao Xu, Redmond, WA (US); Ying Geng, Bellevue, WA (US); Sheng Ye, Redmond, WA (US); Andrew John Ouderkirk, Kirkland, WA (US); Liliana Ruiz Diaz, Bothell, WA (US); Zhaoyu Nie, Kenmore, WA (US)

(21) Appl. No.: 18/371,780

(22) Filed: Sep. 22, 2023

Related U.S. Application Data
(60) Provisional application No. 63/434,718, filed on Dec. 22, 2022.

(51) Int. Cl. F21V 8/00; G02B 27/01

(52) U.S. Cl. CPC G02B 6/0055; G02B 27/0172; G02B 2027/0178

(57) ABSTRACT

A lightguide with partially reflective slanted polarization-selective bulk mirrors is disclosed. The lightguide may be used in a near-eye display with a polarized image source. The polarization-selective bulk mirrors reflect light of the polarized image source, and fully transmit light of the orthogonal polarization, causing the mirrors to be less conspicuous to an external viewer while preserving high efficiency of delivery of the image light to the viewer.

### REFERENCE TO RELATED APPLICATION

The present application claims priority from U.S. provisional patent application No. 63/434,718 filed on Dec. 22, 2022, entitled “Lightguide with Polarization-Selective Bulk Reflectors” and incorporated herein by reference in its entirety.

### TECHNICAL FIELD

The present disclosure relates to visual display devices and related components, modules, and methods.

### BACKGROUND

Visual displays provide information to viewer(s) including still images, video, data, etc. Visual displays have applications in diverse fields including entertainment, education, engineering, science, professional training, advertising, to name just a few examples. Some visual displays such as TV sets display images to several users, and some visual display systems such s near-eye displays (NEDs) are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view images of virtual objects (e.g., computer-generated images (CGIs)) superimposed with the surrounding environment by seeing through a “combiner” component. The combiner of a wearable display is typically transparent to external light but includes some light routing optics to direct the display light into the user's field of view.

Because a display of HMD or NED is usually worn on the head of a user, a large, bulky, unbalanced, and/or heavy display device with a heavy battery would be cumbersome and uncomfortable for the user to wear. Consequently, head-mounted display devices can benefit from a compact and efficient configuration, including efficient light sources and illuminators providing illumination of a display panel, high-throughput ocular lenses, and other optical elements in the image forming train. Furthermore it may be desirable to make such optical elements less noticeable to outside viewers for better social acceptability and for ease of making a visual eye contact with the wearer of the NED.

### BRIEF DESCRIPTION OF THE DRAWINGS

Exemplary embodiments will now be described in conjunction with the drawings, in which:

FIG. 1A is a side cross-sectional view of a lightguide of this disclosure illustrating the image carrying property of the lightguide;

FIG. 1B is a side cross-sectional view of the lightguide of FIG. 1A illustrating light paths of image light and outside light;

FIG. 2A is a magnified side cross-sectional view of a lightguide with 50% reflective polarizers;

FIG. 2B is a magnified side cross-sectional view of a lightguide with non-polarizing 50% reflectors, for comparison with FIG. 2A;

FIG. 2C is a magnified side cross-sectional view of a lightguide with non-polarizing 25% reflectors, for comparison with FIG. 2A;

FIG. 3A is a simulated frontal view of a person wearing AR glasses with lightguide having polarizing partial dot reflectors;

FIG. 3B is a simulated frontal view of a person wearing AR glasses with lightguide having non-polarizing partial dot reflectors, the reflectors being more conspicuous;

FIG. 3C is a simulated frontal view of a person wearing AR glasses with lightguide having polarizing partial stripe reflectors;

FIG. 3D is a simulated frontal view of a person wearing AR glasses with lightguide having non-polarizing partial stripe reflectors, the reflectors being more conspicuous;

FIG. 4 is a magnified side cross-sectional view of a lightguide of this disclosure with polarizing reflectors and an external polarizer;

FIG. 5 is a magnified side cross-sectional view of a lightguide of this disclosure with a birefringent layer polarizer;

FIG. 6 is a magnified side cross-sectional view of a lightguide of this disclosure with a dielectric layer stack polarizer;

FIG. 7 is a magnified side cross-sectional view of a lightguide of this disclosure with a wiregrid polarizer;

FIG. 8 is a side cross-sectional view of a lightguide with polarizing partial reflectors supported by transparent elastic layers;

FIG. 9 is a side cross-sectional view of a lightguide body portion comprising a ridged surface having a plurality of slanted facets;

FIG. 10 is a three-dimensional view of a lightguide including a pair of matching lightguide body portions of FIG. 9;

FIG. 11 is a side cross-sectional view of the lightguide of FIG. 10;

FIG. 12 is a cross-sectional view of a reflective polarizer with stress-imparting side layers;

FIG. 13 is a side cross-sectional view of a curved lightguide of this disclosure;

FIG. 14 is a side cross-sectional view of a lightguide of this disclosure with embedded transmission polarizers;

FIG. 15 is a side cross-sectional view of a lightguide of this disclosure with an array of optical retarders coupled to the partial reflective polarizers;

FIG. 16 is a spectral plot showing banded spectral transmission of reflective polarizers, according to an embodiment;

FIG. 17A is a flow chart of a method of manufacturing a lightguide of this disclosure;

FIG. 17B is a side cross-sectional view of a stack of reflective polarizers for manufacturing the lightguide using the method of FIG. 17A;

FIG. 18 is a combined side and plan view of a pupil-replicating lightguide with slanted partial polarization-selective stripe reflectors;

FIG. 19 is a schematic view of a near-eye display including a lightguide of this disclosure;

FIG. 20 is a view of wearable display of this disclosure having a form factor of a pair of eyeglasses; and

FIG. 21 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

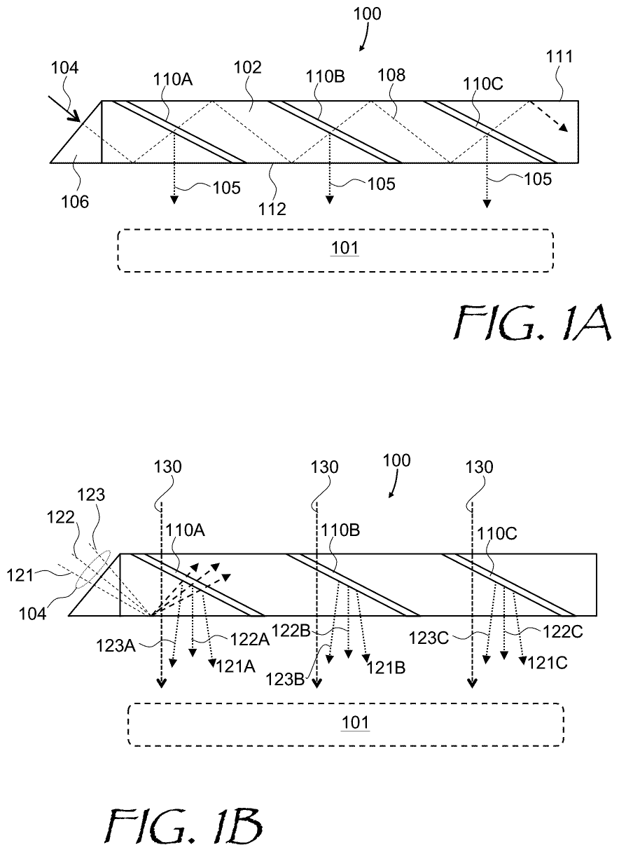

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1A-1B, 2A-2C, 3A-3D, FIG. 4-FIG. 8, FIG. 11, FIG. 13-FIG. 15, and FIG. 18, similar reference numerals generally denote similar elements.

Near-eye displays and augmented reality displays may use pupil-replicating lightguides to expand image light carrying a projected image over an eyebox of the display, i.e., over an area where a user's eye may be located during normal operation of the display. A pupil-replicating lightguide may include a parallel slab of a transparent material propagating the image light in a zigzag pattern by total internal reflection (TIR) from the lightguide's top and bottom surfaces that run parallel to one another. Partial bulk reflectors may be used to out-couple portions of the image light along its zigzag lightpath. The reflectivity of the partial bulk reflectors may be selected to gradually decrease from an upstream reflector to a downstream reflector, to offset the optical power drop of the image light as its portions are out-coupled by upstream partial reflector(s). Herein, the term “bulk reflector” denotes a continuous, non-diffracting surface capable of at least partially reflecting light, e.g. a Fresnel surface, a metallic surface, a wiregrid surface, etc., as opposed to diffracting structures such as volume Bragg gratings or polarization volume holograms, which are not considered bulk reflectors.

One drawback of lightguides with partial reflector out-couplers is that the partial reflectors may be noticeable to outside viewers. The visible partial reflectors may obscure, or distract from the eyes of the wearer of the near-eye display, reducing the social acceptance of the display and discouraging the display owner from wearing it in public.

In accordance with this disclosure, the partial bulk reflectors of a lightguide may be made less noticeable to outside viewers, i.e. less conspicuous, by making partial reflectors polarization selective. The polarization-selective partial bulk reflectors partially reflect light of a first polarization while transmit through the light of a second, orthogonal polarization. Since the external light is not polarized, such reflectors may be less visible to outside viewers. Furthermore, by placing a transmission polarizer at the distal side of the lightguide, the external light may be polarized to have the second polarization state, in which the light propagates freely through the partial reflective polarizers, making the latter nearly completely inconspicuous. In embodiments where an external polarization dimmer is used upstream of the display for whatever reason e.g. to reduce glare, reduce brightness of outside imagery, etc., the incoming light may be polarized by the polarization dimmer to have the second polarization state.

In accordance with the present disclosure, there is provided a lightguide for conveying image light in a display device. The lightguide comprises a lightguide body comprising first and second opposed surfaces running parallel to each other for propagating the image light within the lightguide body along a zigzag light path. The zigzag light path is defined by alternating reflections of the image light from the first and second surfaces. The lightguide further includes an array of polarization-selective slanted bulk reflectors along the zigzag light path within the lightguide body for out-coupling light in a first polarization state while transmitting therethrough light in a second, orthogonal polarization state. In operation, laterally offset polarized portions of the image light are out-coupled from the lightguide body towards an eyebox of the display device.

Polarization-selective slanted bulk reflectors of the array may each comprise a multilayer birefringent polymer film, cholesteric liquid crystals, a dielectric layer stack, a dichroic layer stack, a wiregrid polarizer, etc. In some embodiments, polarization-selective slanted bulk reflectors of the array may have a reflectivity range for the image light of between e.g. 4% and 80% for one polarization and about 0%, e.g. less than 1% for the other, orthogonal polarization, and/or a high enough refractive index e.g. greater than 1.65.

The polarization-selective slanted bulk reflectors may be configured to lessen a reflection of outside light from the polarization-selective slanted bulk reflectors when the outside light impinges onto the first surface of the lightguide body at a normal angle of incidence. In some embodiments, the polarization-selective slanted bulk reflectors may be configured to lessen a reflection of outside light from the polarization-selective slanted bulk reflectors when the outside light impinges onto the lightguide body at an angle of incidence of less than 70 degrees w.r.t. a normal to the lightguide body. The lightguide may include elastic layers between polarization-selective bulk reflectors of the array and the lightguide body.

In some embodiments, the lightguide body comprises a first lightguide body portion comprising the first surface of the lightguide body on one side and a first ridged surface on an opposite side, the first ridged surface comprising a first plurality of slanted facets; and a second lightguide body portion comprising the second surface of the lightguide body on one side and a second ridged surface on an opposite side, the second ridged surface comprising a second plurality of slanted facets. The first and second lightguide body portions may match one another when put together. Polarization-selective slanted bulk reflectors of the array of polarization-selective slanted bulk reflectors may be sandwiched between corresponding slanted facets of the first and second pluralities of slanted facets of the first and second lightguide body portions respectively.

The lightguide may further include a first bonding layer between polarization-selective bulk reflectors of the array and slanted facets of the first plurality of slanted facets, and a second bonding layer between polarization-selective bulk reflectors of the array and slanted facets of the second plurality of slanted facets.

In some embodiments, polarization-selective slanted bulk reflectors of the array include a polarization-selective reflector layer and a pair of stress-imparting layers on opposite sides of the polarization-selective reflector layer, for imparting compressive stress thereto. In such embodiments, the stress-imparting layers may have a coefficient of thermal expansion higher than that of the polarization-selective reflector layer. The stress-imparting layers may be hot laminated onto the polarization-selective reflector layer. The first and second surfaces may be flat, form a meniscus shape having a simple or complex shape, etc.

In some embodiments, a spectral bandwidth of the polarization-selective slanted bulk reflectors is tunable by applying at least one of an electric or magnetic field, whereby optical transmission of outside light through the polarization-selective slanted bulk reflectors is variable. In such embodiments, the polarization-selective slanted bulk reflectors may include at least one of helicoidal cholesteric liquid crystals or ferroelectric nematic liquid crystals.

In some embodiments, the polarization-selective slanted bulk reflectors have a reflection bandwidth of less than 40 nm for a color channel of the image light propagating within the lightguide body. The polarization-selective slanted bulk reflectors may be configured to lessen a reflection of outside light therefrom when the outside light impinges onto the dielectric layer stack at an angle of incidence of greater than 70 degrees. In embodiments where the lightguide body comprises a polymer material preserving a polarization state of the image light propagating therein, the polymer material may have a difference between ordinary and extraordinary indices of refraction of less than 0.1, and/or the polymer material may have an elasticity modulus of less than 1 GPa.

In some embodiments, the lightguide further includes a transmissive polarizer coupled to the first surface for polarizing impinging external light to have the second polarization state. The lightguide may further include an array of optical retarders along the zigzag light path within the lightguide body for changing a polarization state of the image light propagating along the zigzag light path. The retarders may be tunable by application of a control signal.

In accordance with the present disclosure, there is provided a display apparatus having a light engine for providing image light carrying an image in angular domain, and a lightguide of this disclosure for expanding the image light over an eyebox of the display apparatus. The light engine may include e.g. a liquid crystal display, a liquid crystal on silicon (LCoS) display, a micro-LED display, and/or a laser diode coupled to a tiltable reflector. The light engine may include a light source having a spectral bandwidth including red, green, and blue light.

In accordance with the present disclosure, there is provided a method for manufacturing a lightguide for conveying image light in a display device. The method includes obtaining a plurality of polymer plates each having a reflective polarizer bonded to the corresponding polymer plate; bonding the polymer plates together, to form a stack; and dicing the stack at an acute angle, to obtain a lightguide body comprising an array of polarization-selective slanted bulk reflectors, each polarization-selective slanted bulk reflector comprising one of the polymer plates having one of the reflective polarizers bonded to the corresponding polymer plate. First and second opposed surfaces of the lightguide body may be polished, and the lightguide body may be assembled into the lightguide.

Referring now to FIG. 1A, a lightguide 100 may be used to convey image light 104 to an eyebox 101 of a display device, e.g. a near-eye display device. The lightguide 100 includes a lightguide body 102 comprising first 111 and second 112 opposed surfaces. The first 111 and second 112 surfaces may be flat as shown, curved, etc., for as long as the first 111 and second 112 surfaces run parallel to one another. The first 111 and second 112 opposed surfaces may be outer surfaces of the lightguide body 102. The lightguide body 102 may include a transparent substrate such as glass, plastic, oxide, or inorganic crystal substrate, for example. The transparent substrate may have flat or curved outer surfaces, and may be coated with a low-index material for protection against dirt and fog.

The image light 104 is in-coupled by an optional in-coupler 106, in this example a prismatic in-coupler. The image light 104 propagates within the lightguide body 102 along a zigzag light path 108 defined by alternating reflections of the image light 104 from the first 111 and second 112 surfaces of the lightguide body 102. The image light 104 carries an image to be displayed. The image light 104 carries an image in angular domain, i.e. an image where individual image elements (pixels) are represented by a ray angle of a ray fan covering an entire field of view (FOV) of the image. The brightness and/or color of the pixels of the image in angular domain are represented by brightness and/or color of a light ray at the corresponding ray angle.

An array of slanted partial bulk reflectors 110A, 110B, and 110C (collectively 110) is disposed within the lightguide body 102 along the zigzag light path 108. More than three partial bulk reflectors 110 may be provided. The partial bulk reflectors 110 may be slanted in a parallel manner, i.e. may be parallel to one another with a same slant angle. Herein, the term “slanted” means forming an acute angle with the first 111 and second 112 surfaces of the lightguide body 102. In operation, the slanted partial bulk reflectors 110 out-couple laterally offset portions 105 of the image light 104 from the lightguide body 102 towards the eyebox 101.

FIG. 1B further illustrates how the lightguide 100 may convey an image to the eyebox 101. The image being carried by the image light 104 is an image in angular domain, where a pixel of the image is represented by a ray angle of ray of the image light emitted by the pixel. Accordingly, different pixels are represented by different ray angles. In FIG. 1B, an image in angular domain is represented by a ray fan including first 121, second 122, and third 123 rays at different ray angles. In operation, the in-coupler 106 in-couples the first 121, second 122, and third 123 rays into the lightguide body 102. The first 121, second, 122, and third 123 rays are totally internally reflected from the second surface 112 of the lightguide body 102, and then are partially reflected by the leftmost slanted partial bulk reflector 110A, providing first 121A, second 122A, and third 123A beam portions preserving the ray angles of the original first 121, second, 122, and third 123 rays of the image light 110. The remaining portion of the image light 104 propagates through the lightguide 100 by a series of total internal reflections from the first 111 and second 112 surfaces (not illustrated for brevity), producing beam portions 121B, 122B, and 123B reflected from the center slanted partial bulk reflector 110B, beam portions 121C, 122C, and 123C reflected from the right-side slanted partial bulk reflector 110C, and so on, effectively spreading the image light across the eyebox 101. Since the ray angles of the beam portions are preserved, the viewer may be able to see the image carried by the image light 104 anywhere in the eyebox 101. Furthermore, since the lightguide body 102 is transparent, the viewer may be able to see the outside world image carried by outside light 130, also termed external light 130, through the lightguide body 102.

As noted above, one drawback of a lightguide with partial bulk reflectors, such as the lightguide 100, is that the slanted partial bulk reflectors 110A, 110B, and 110C may be readily noticeable by outside viewers. It may be socially an aesthetically unacceptable for the user to wear such augmented reality goggles in most public settings. In accordance with this disclosure, the slanted bulk reflectors 110 may be made polarization-selective. Polarization-selective slanted partial bulk reflectors out-couple light in the first polarization state while transmitting light in a second, orthogonal polarization state. By providing the image light in the first polarization state, the image light may be reflected more efficiently than unpolarized outside light, making the partial slanted bulk reflectors less conspicuous and/or improving the efficiency of out-coupling the laterally offset polarized portions of the image light. Furthermore, by polarizing the outside light to have the second polarization state, the partial slanted bulk reflectors may be made nearly invisible to outside viewers, because the light in the second polarization states propagates through the polarization-selective bulk reflectors substantially without reflecting. By way of a non-limiting illustrative example, polarization-selective slanted bulk reflectors may have a reflectivity range for the image light of between 4% and 80% for one polarization, and close to 0% for the other, orthogonal polarization. In some embodiments, the polarization-selective slanted bulk reflectors may have a refractive index of greater than 1.65.

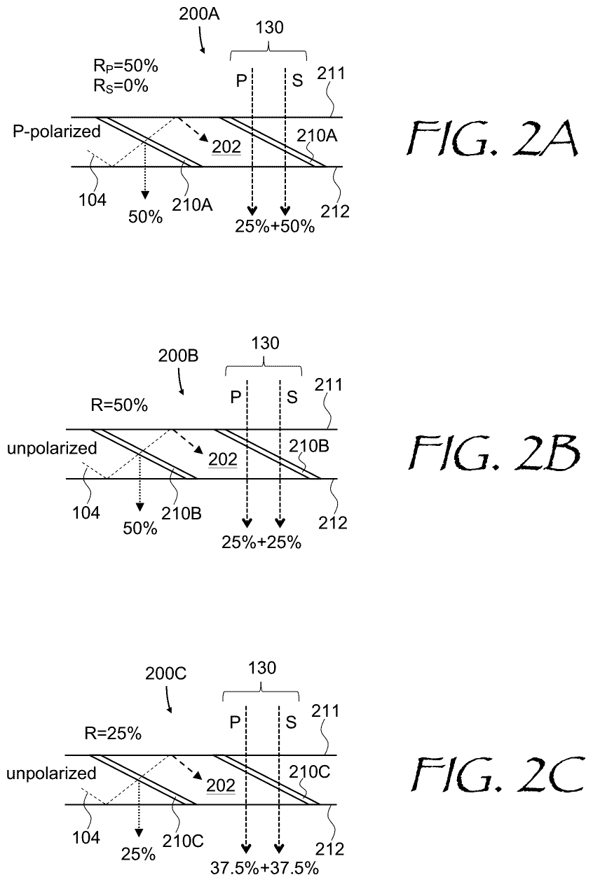

The effect of the polarization-selective partial bulk reflectors on conspicuity is illustrated in FIGS. 2A, 2B, and 2C. FIG. 2A illustrates a lightguide 200A with polarization-selective partial bulk reflectors, while FIGS. 2B and 2C illustrate lightguides 200B and 200C respectively, with non-polarization-selective partial bulk reflectors having 50% and 25% reflectivity respectively.

Referring first to FIG. 2A, the lightguide 200A includes a lightguide body 202 having first 211 and second 212 surfaces, in this example flat outer surfaces, which run parallel to one another. Partial reflective polarizers 210A reflect 50% of P-polarized light, while substantially not reflecting S-polarized light. In other words, the P-reflectivity R_{P} is 50%, while the S-reflectivity R_{S} is 0%. The image light 104 is P-polarized, thus the partial reflective polarizer 210A will reflect 50% of the image light 104, as illustrated. The outside light 130, i.e. the external light 130, is not polarized, and accordingly its P-polarized and S-polarized components are of equal optical power. In other words, each of the P-polarized and S-polarized components of the external light 130 are each 50% of the total optical power of the external light 130. Half of the P-component of the external light 130 is reflected by the partial reflective polarizer 210A, hence transmitting 25% of the total optical power of the external light 130. The entire S-polarized component of the external light 130 propagates through, transmitting another 50% of the total optical power of the external light 130. Thus, the total transmitted power ratio is 75%.

FIG. 2B illustrates the lightguide 200B with non-polarization-selective partial bulk reflectors, for comparison with FIG. 2A. In FIG. 2B, partial bulk reflectors 210B have a 50% reflectivity, thus the partial reflective polarizer 210B will reflect 50% of the image light, as illustrated. The outside light 130 will also be transmitted at 50%. By comparing FIG. 2B with FIG. 2A, one can see that the reflectivity of the image light 104 in both cases is 50%. The transmissivity of the external light 130 in the case of FIG. 2A, i.e. with the polarization-selective partial reflective polarizers 210A, is 75%, while the transmissivity of the external light 130 in the case of FIG. 2A, i.e. with the non-polarization-selective partial reflective polarizers 210B, is only 50%. In other words, at a same efficiency of conveying image light to the eyebox, the polarization-selective slanted bulk reflectors 210A of FIG. 2A transmit 25% more light than the non-polarization-selective slanted bulk reflectors 210B of FIG. 2B. Therefore, the polarization-selective slanted bulk reflectors 210A of FIG. 2A are less conspicuous to both the wearer of the near-eye display and the outside viewer at a same image light utilization efficiency corresponding to a same reflectivity of 50%.

Turning to FIG. 2C, partial bulk reflectors 210C of the lightguide 200C are non-polarization-selective at 25% reflectivity. Accordingly, only 25% of the image light 104 will be reflected by the first partial bulk reflector 210C. Similarly, 25% of the external light will be reflected by the partial bulk reflector 210C and accordingly, the transmissivity of the external light 130 will be 75%. Therefore, at a same conspicuity of the slanted bulk reflectors as in the case of FIG. 2A, the image light utilization efficiency will be lower by 50% (i.e. 25% instead of 50% as in the case of FIG. 2A). Therefore, the utilization of polarization-selective slanted partial reflectors in a lightguide improves at least one of the image light utilization or the inconspicuity of the slanted bulk reflectors.

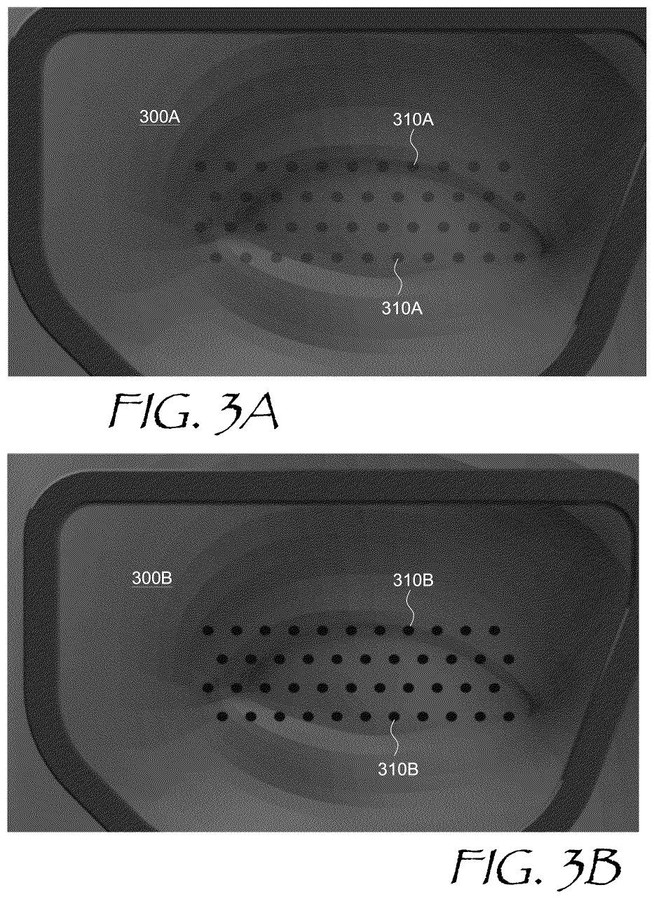

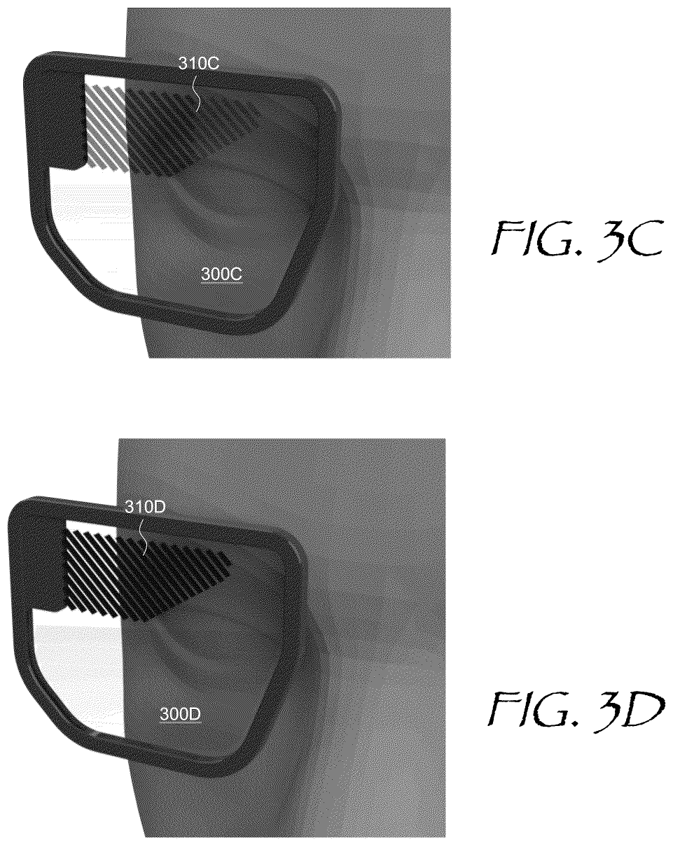

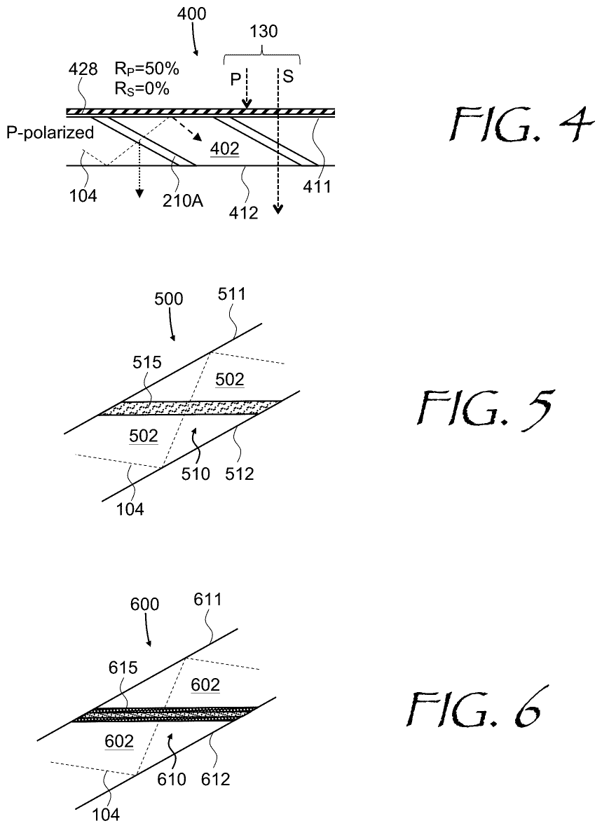

The latter point is illustrated in FIGS. 3A to 3D. FIG. 3A depicts an AR goggle including a lightguide 300A with polarization-selective slanted bulk reflectors 310A that have a shape of small dots. FIG. 3B depicts an AR goggle including a lightguide 300B with non-polarization-selective slanted dot reflectors 310B which appear more opaque, and thus more conspicuous, to an outside observer. The AR goggles of FIG. 3A may be more socially acceptable than the AR goggles of FIG. 3B, because the polarization-selective slanted bulk reflectors 310A are less conspicuous at a same image light utilization efficiency by the goggle's lightguides.

FIG. 3C depicts an AR goggle including a lightguide 300C with polarization-selective slanted bulk reflectors 310C that have a shape of elongated stripes. FIG. 3D depicts an AR goggle including a lightguide 300D with non-polarization-selective slanted striped reflectors 310D which appear more opaque, and thus more conspicuous, to an outside observer. The AR goggles of FIG. 3C may be more socially acceptable than the AR goggles of FIG. 3D, because the polarization-selective slanted bulk reflectors 310C are less conspicuous at a same image light utilization efficiency by the goggle's lightguides.

By way of non-limiting illustrative examples, polarization-selective slanted bulk reflectors of this disclosure, e.g. the polarization-selective slanted bulk reflectors 210A of FIG. 2A, the polarization-selective slanted bulk reflectors 310A of FIG. 3A, the polarization-selective slanted bulk reflectors 310C of FIG. 3C, and others considered below, may have a reflectivity range for the image light of e.g. between 4% and 80% for one polarization, and close to 0% (e.g. less than 1% or 0.1%) for the other, orthogonal polarization. In some embodiments, the polarization-selective slanted bulk reflectors 210A may have a refractive index of e.g. greater than 1.65.

Turning to FIG. 4 with further reference to FIG. 2A, a lightguide 400 (FIG. 4) is similar to the lightguide 200A of FIG. 2A, and includes same or similar elements as the lightguide 200A of FIG. 2A, i.e. a lightguide body 402 having first 411 and second 412 surfaces running parallel to one another, in this example flat surfaces. The lightguide 400 of FIG. 4 further includes a transmissive polarizer 428 coupled to the upstream surface, i.e. to the first surface 411 of the lightguide body 402 w.r.t. the external unpolarized light 130. The transmissive polarizer 428 is configured to fully transmit light having a polarization state at which the polarization-selective partial bulk reflectors 210A transmit light, in this example S-polarization. Thus, only the S-polarized portion of the external light 130 will propagates through the lightguide body 402, making the polarization-selective partial bulk reflectors 210A nearly invisible to an outside viewer.

Referring now to FIG. 5 with further reference to FIG. 2A, a lightguide 500 is similar to the lightguide 200A of FIG. 2A, and includes similar elements. The lightguide 500 of FIG. 5 includes a lightguide body 502 having first 511 and second 512 opposed flat parallel outer surfaces. The image light 104 propagates in the lightguide body 502 by a series of internal reflections from the first 511 and second 512 surfaces. Partial reflective polarizers 510 (only one is shown) out-couple portions of the image light 104 for observation by a viewer. The partial reflective polarizers 510 include a layer 515 of a birefringent material having ordinary and extraordinary indices of refraction, one of which may be matched to the index of refraction of the lightguide body 502, causing light at the polarization corresponding to the matched index of refraction to propagate through the partial reflective polarizer 510 substantially without reflection losses. The light at the other, orthogonal polarization will undergo a Fresnel reflection due to refractive indices mismatch.

In some embodiments, the birefringent layer 515 includes cholesteric liquid crystals that reflect light of one handedness of a circular polarization while transmitting through light at the circular polarization of the opposite handedness, such as e.g. oblique helicoid (ChOH) cholesteric liquid crystals or N_{tb}* cholesteric liquid crystals. In some embodiments, the birefringent layer 515 includes ferroelectric nematic liquid crystals, such as e.g. NF* ferroelectric nematic liquid crystals. Using liquid crystals allows the spectral bandwidth of the polarization-selective slanted bulk reflectors to be tunable by applying at least one of an electric or magnetic field, whereby optical transmission of outside light through the polarization-selective slanted bulk reflectors may be made variable. Furthermore in some embodiments, the birefringent layer 515 may include a multilayer birefringent polymer film having several layers of a birefringent polymer.

Turning to FIG. 6 with further reference to FIG. 2A, a lightguide 600 is similar to the lightguide 200A of FIG. 2A, and includes similar elements. The lightguide 600 of FIG. 6 includes a lightguide body 602 having first 611 and second 612 opposed flat parallel outer surfaces. The image light 104 propagates in the lightguide body 602 by a series of internal reflections, e.g. total internal reflections, from the first 611 and second 612 surfaces. Partial reflective polarizers 610 (only one is shown) out-couple portions of the image light for observation by a viewer. The partial reflective polarizers 610 include a dielectric layer stack 615. Thicknesses and refractive indices of layers of the dielectric layer stack 615 are selected to optimize reflection of light of only one polarization, typically a linear polarization, while reducing reflection of light of the orthogonal polarization, thus making the dielectric layer stack 615 a partial polarization-selective linear polarizer. Furthermore in some embodiments, the dielectric layer stack is optimized to reduce reflection of external light, thus making such partial reflectors less conspicuous to external viewers. For example, the dielectric layer stack 615 may be configured to lessen a reflection of outside light from the dielectric layer stack 615 when the outside light impinges onto the dielectric layer stack 615 at an angle of incidence of less than 45 degrees, which may correspond to the angles of incidence onto the lightguide 600 of less than 70 degrees. Other types of polarization selective slanted bulk reflectors may also be configured to lessen the reflection of outside light at the stated range or similar ranges of incidence angles.

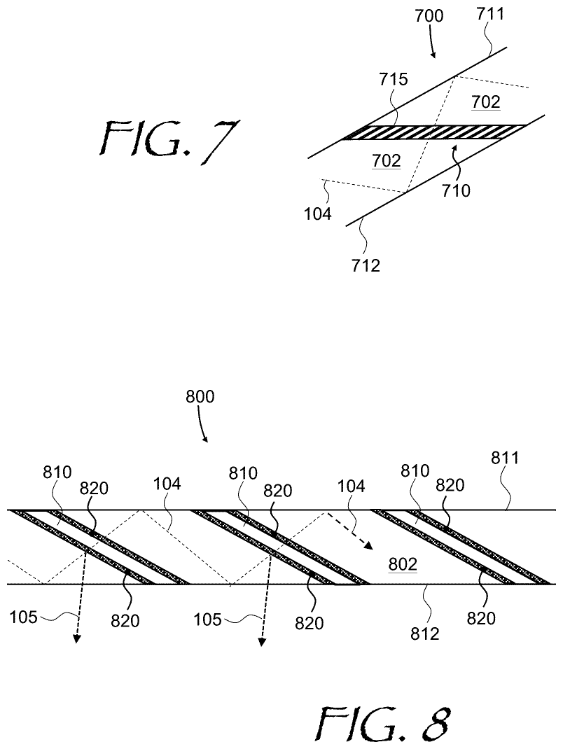

Referring to FIG. 7 with further reference to FIG. 2A, a lightguide 700 is similar to the lightguide 200A of FIG. 2A, and includes similar elements. The lightguide 700 of FIG. 7 includes a lightguide body 702 having first 711 and second 712 opposed flat parallel outer surfaces. The image light 104 propagates in the lightguide body 702 by a series of inner reflections from the first 711 and second 712 surfaces. Partial reflective bulk polarizers 710 (only one is shown) out-couple portions of the image light for observation by a viewer. The partial reflective bulk polarizers 710 include a wiregrid polarizer 715. Length, direction, and composition of nanowires of the wiregrid polarizer 715 are selected to cause the wiregrid polarizer 715 to at least partially reflect light of a first polarization while transmitting substantially without reflection light of a second, orthogonal polarization.

Turning to FIG. 8 with further reference to FIG. 2A, a lightguide 800 is similar to the lightguide 200A of FIG. 2A, and includes similar elements. The lightguide 800 of FIG. 8 includes a lightguide body 802 having first 811 and second 812 opposed flat parallel outer surfaces. The image light 104 propagates in the lightguide body 802 by a series of internal reflections from the first 811 and second 812 surfaces, as illustrated. An array of polarization-selective bulk reflectors 810 out-couple portions 105 of the image light 104 for observation by a viewer. The lightguide 800 includes elastic layers 820 between the polarization-selective bulk reflectors 810 and the lightguide body 802 surrounding them. The purpose of the elastic layers 820 is to compensate for a mismatch of coefficients of thermal expansion (CTE) of the lightguide body 802 material and the polarization-selective bulk reflectors 810 material. Without the elastic layers 820, a CTE mismatch may cause delamination of the polarization-selective bulk reflectors 810 from the lightguide body 802, causing a structural failure.

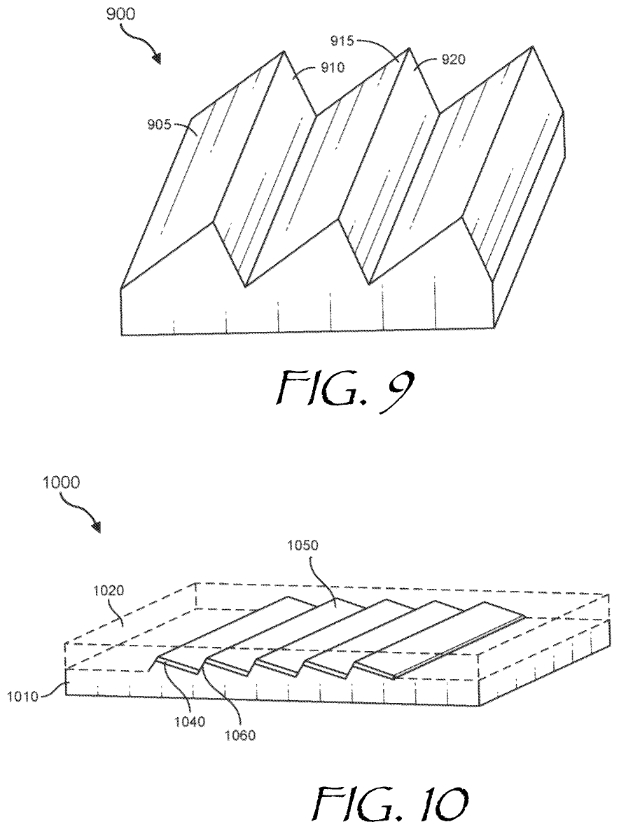

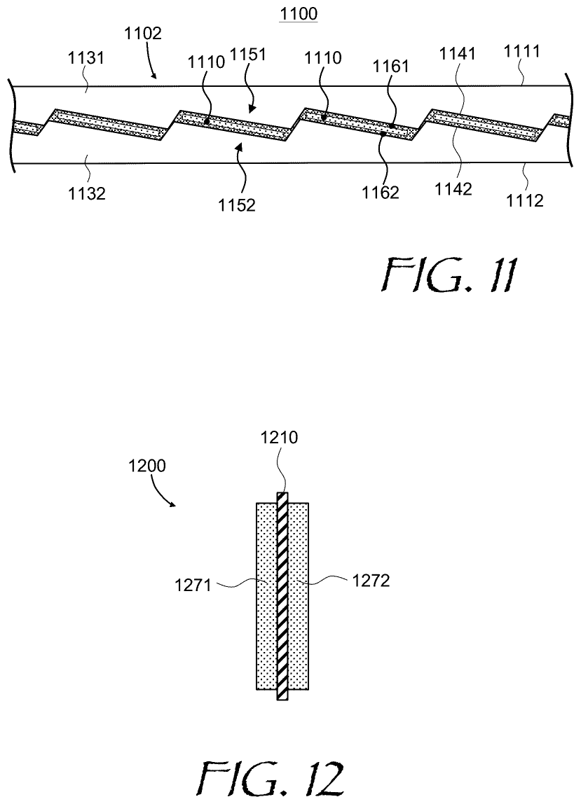

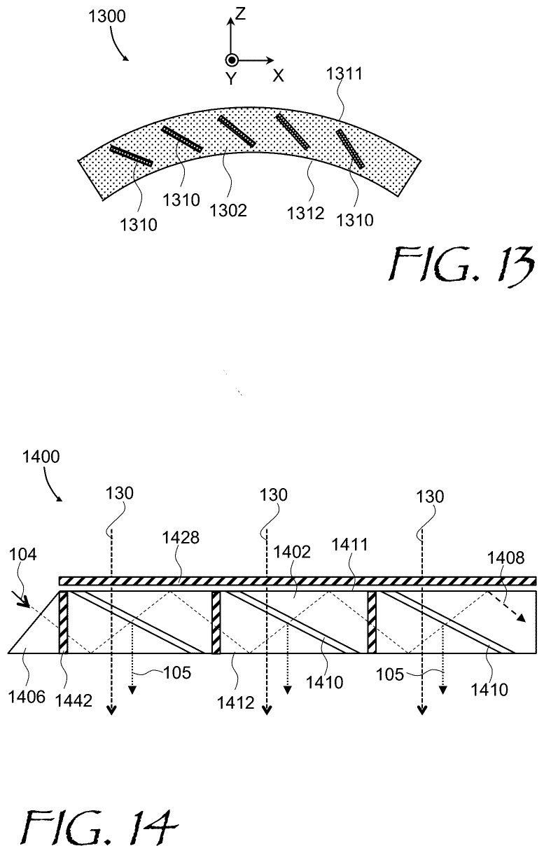

In the embodiment illustrated in FIG. 8, the polarization-selective bulk reflectors 810 extend from the first 811 to the second 812 surface of the lightguide body 802. In some embodiments, polarization-selective slanted bulk reflectors do not extend fully between the outer surfaces of a lightguide body, and instead are “buried” or disposed inside a lightguide body, without extending all the way from one surface of the lightguide body to the other. One such embodiment is illustrated in FIGS. 9, 10, and 11.

Referring first to FIG. 9, a lightguide body portion 900 including slanted facets (e.g., facets 905 and 915) and steps (e.g., steps 910 and 920) is illustrated. In this example, the lightguide body portion 900 has generally linear facets. In some examples, the facets may include circular facets or other facet shapes, such as oval, elliptical, annular, linear (e.g., rectangular), and the like.

FIG. 10 shows a lightguide body 1000 including a lightguide body portion 1010, a filler layer 1020 that planarizes the upper surface of the lightguide body 1000, and polarization-selective slanted bulk reflectors 1040 and 1050 disposed on the facets of the lightguide body portion 1010. In this example, the polarization-selective slanted bulk reflectors 1040 and 1050 may be generally rectangular. However, polarization-selective slanted bulk reflectors 1040 and 1050 sized to cover corresponding facets of a lightguide body portion may be of any appropriate shape. A step 1060 may be located between adjacent polarization-selective slanted bulk reflectors 1040 and 1050. In the embodiment shown in FIG. 10, the step 1060 does not support a polarization-selective slanted bulk reflector.

In some examples, a lightguide body may include a lightguide body portion having a faceted surface on one side, a non-faceted surface on the other, opposed side, and a polarizer, e.g. a transmissive or reflective polarizer, located on the non-faceted surface. By way of a non-limiting illustrative example, a polarizer may be located on a planar, concave or convex surface of a lightguide body portion. In some examples, the faceted surface may be smoothed out (e.g., planarized) using a filler layer, and the polarizer may be located on the filler layer. In some examples, the filler layer may have a first surface that conforms to the faceted surface of a lightguide body portion and a second surface that is a planar surface or a non-faceted (smooth) curved surface such as a concave or convex surface. In some examples, the polarizer may be located on the second surface of the filler layer. In some examples, reflective polarizers may be located on the slanted facets of the lightguide body portion and a filler layer may be located over the reflective polarizer and lightguide body portion and may act as a protective layer.

In some examples, a lightguide body may include a lightguide body portion such as those shown in FIGS. 9 and 10, having a reflective polarizer formed on at least one facet. An example lightguide body portion may also include a peripheral edge coated with a light absorbent coating. In some examples, a lightguide body portion may include a curved surface without facets, such as a convex or concave surface. In some examples, a lightguide body portion may include a curved surface having facets and steps. The steps may allow a reduction in the lightguide thickness.

In some examples, a lightguide body may include a matched pair of lightguide body portions each having a planar surface and an opposed surface including facets and steps. FIG. 11 illustrates one such lightguide example. A lightguide body 1102 has first 1111 and second 1112 opposed surfaces, for the image light to propagate in the lightguide body 1102 by a series of internal reflections from the first 1111 and second 1112 surfaces. The lightguide body 1102 further includes an array of polarization-selective slanted bulk reflectors 1110 for out-coupling portions of the image light from the lightguide body 1102.

The lightguide body 1102 includes a first lightguide body portion 1131 comprising the first surface 1111 of the lightguide body 1102 on one side and a first ridged surface 1141 on an opposite side. The first ridged surface 1141 includes a first plurality of slanted facets 1151. The lightguide body 1102 further includes a second lightguide body portion 1132 comprising the second surface 1112 of the lightguide body 1102 on one side and a second ridged surface 1142 on an opposite side. The second ridged surface 1142 includes a second plurality of slanted facets 1152. The first 1131 and second 1132 lightguide body portions match one another when put together. The polarization-selective slanted bulk reflectors 1110 may be sandwiched between corresponding slanted facets 1151 and 1152 of the first 1131 and second 1132 lightguide body portions respectively.

In some embodiments, the lightguide body 1102 further includes a first bonding layer 1161 between the polarization-selective bulk reflectors 1110 and the slanted facets 1151 of the first plurality, and a second bonding layer 1162 between the polarization-selective bulk reflectors 1110 and the slanted facets 1151 of the second plurality. The first 1161 and/or second 1162 bonding layers may function as filler layers, and may include e.g. an adhesive layer and/or a polymer layer. The adhesive and/or polymer layers may be elastic for accommodating the mechanical stress resulting from the CTE mismatch of the polarization-selective bulk reflectors 1110 and the first 1131 and second 1132 portions of the lightguide body 1102, similarly to the elastic layers 820 of the lightguide 800 of FIG. 8. At least one of the first 1161 or second 1162 bonding layers may have a modulus of elasticity of between 0.1 GPa and 10 GPa, or between 0.5 GPa and 5 GPa, or greater than 1 GPa in some embodiments. Another way to relieve the mechanical stress caused by CTE mismatch of the slanted partial reflectors and supporting lightguide body is to manufacture the lightguide body from an isotropic polymer material with an elasticity of between 0.5 GPa and 10 GPa.

A lightguide of this disclosure may use an array of partial reflectors, which include stress imparting layers. One of such partial reflectors is illustrated in FIG. 12. A reflector 1200 includes a polarization-selective reflector layer 1210 and a pair of stress-imparting layers 1271, 1272 on opposite sides of the polarization-selective reflector layer 1210, for imparting compressive stress to the polarization-selective reflector layer 1210. The stress-imparting layers 1271, 1272 may be made out of a transparent isotropic material with a CTE closer to that of the surrounding lightguide body than the CTE of the polarization-selective reflector layer 1210. In some embodiments, the stress-imparting layers 1271, 1272 have a coefficient of thermal expansion higher than that of the polarization-selective layer. For such embodiments, the stress-imparting layers 1271, 1272 may be hot laminated onto the polarization-selective reflector layer 1210, such that upon cooling down to a normal operating temperature, the polarization-selective reflector layer 1210 is under compressive stress.

As noted above, the lightguide body of this disclosure may include a pair of opposed surfaces running parallel to one another. The surfaces are not necessarily flat, for as long as they stay parallel. Referring for a non-limiting illustrative example to FIG. 13, a lightguide 1300 includes a meniscus-shaped lightguide body 1302 having first 1311 and second 1312 opposed curved surfaces running parallel to each other.

The meniscus shape may follow a simple curve or a complex curve in XZ plane, i.e. in a cross-section including one of length or width dimensions and a thickness dimension of the lightguide body 1302. Herein, the term “simple curve” denotes a curve is one that can be easily formed, e.g. by bending a flat plate or a similar simple operation. An example is a cylindrical meniscus shape. The term “compound curve” is taken to mean, for example, a spherical or an aspherical meniscus shape.

To preserve the image-carrying property of the lightguide body 1302, the latter may be made of a material having a refractive index that varies along the thickness dimension of the lightguide body 1302, i.e. along the X-axis in FIG. 13. The refractive index at the bottom of the meniscus-shaped lightguide body 1302 may be greater than the refractive index at the top of the meniscus-shaped lightguide body 1302. In operation, the image light is propagated within the lightguide body 1302 along a zigzag light path defined by the refractive index gradient and the alternating reflections of the image light from the first 1311 and second 1312 surfaces. Partial slanted polarization-selective bulk reflectors 1310 out-couple portions of the image light 104 from the lightguide body 1302.

Turning now to FIG. 14 with further reference to FIG. 2A, a lightguide 1400 is similar to the lightguide 200A of FIG. 2A, and includes similar elements. The lightguide 1400 of FIG. 14 includes a lightguide body 1402 having first 1411 and second 1412 opposed flat parallel outer surfaces. The image light 104 is in-coupled into the lightguide body 1402 by a prismatic in-coupler 1406. The in-coupled image light 104 propagates in the lightguide body 1402 by a series of inner reflections from the first 1411 and second 1412 surfaces along a zigzag light path 1408. An array of polarization-selective bulk reflectors 1410 out-couple the portions 105 of the image light 104 for observation by a user. The lightguide 1400 further includes a set of polarizers 1442 for polarizing the image light 104 propagating along the zigzag light path 1408 to have the first polarization state, i.e. the polarization state for the image light 104 to get reflected by the polarization-selective bulk reflectors 1410. The polarizers 1442, e.g. linear transmission polarizers, facilitate maintaining the required polarization of the image light 104. At least one polarizer 1442 may be provided. The external light 130 may be polarized to have the second polarization state by an upstream linear transmission polarizer 1428.

Referring to FIG. 15 with further reference to FIG. 2A, a lightguide 1500 is similar to the lightguide 200A of FIG. 2A, and includes similar elements. The lightguide 1500 of FIG. 15 includes a lightguide body 1502 having first 1511 and second 1512 opposed surfaces running parallel to one another. The lightguide body 1502 may include a transparent substrate such as, for example, glass, plastic, oxide, and/or an inorganic crystal substrate. The lightguide 1500 includes an input coupler 1506, e.g. an in-coupling prism (as illustrated) and/or an in-coupling mirror, configured to couple the image light 104 into the lightguide body 1502. The input coupler 1506 may include a polarizing element such as a linear polarizer, for example.

The lightguide body 1502 further includes a plurality of polarization-selective slanted bulk reflectors or mirrors 1510. The polarization-selective slanted bulk reflectors 1510 may be parallel to one another. Upon having been coupled into the lightguide body 1502 by the input coupler 1506, the image light 104 propagates along a zigzag light path 1508 within the lightguide body 1502 by a series of total internal reflections (TIRs) from the first 1511 and second 1512 surfaces of the lightguide body 1502, as illustrated.

The lightguide body 1502 may further include an array of optical retarders 1580 disposed along the zigzag light path 1508 within the lightguide body 1502 for changing a polarization state of the image light 104 propagating along the zigzag light path 1508. At least some of the optical retarders 1580 may have tunable optical retardation. The optical retardation may be tuned by application of an external signal. For example, some of the optical retarders 1580 may include liquid crystals or liquid crystal (LC) cells. The LC cells 1580 may be disposed in the light path 1508 upstream of each polarization-selective slanted bulk reflector 1510 as illustrated, although in some embodiments, the LC cells 1580 may be disposed downstream of the respective polarization-selective slanted bulk reflectors 1510. The LC cells 1580 may include a pair of transparent electrodes for polarization control uniform across the entire LC cell 1580. The LC cells 1580 may be disposed near to and/or parallel to the respective polarization-selective slanted bulk reflectors 1510, and may form stacks with the respective bulk mirrors 1510, as illustrated.

The purpose of the LC cells 1580 is to control the polarization state of the image light 104 along the light path 1508, and accordingly to control the spatial distribution of the out-coupled portions 105 of the image light 105 via the polarization state of the image light 105. If, for example, the polarization-selective slanted bulk reflectors 1510 are configured to reflect light of a first linear polarization and transmit through light of a second, orthogonal polarization, the LC cell(s) 1580 may be tuned to convert the polarization state of the image light 104 to be the first polarization state when out-coupling by respective downstream bulk mirror(s) 1510 is required. By the same principle, the LC cell(s) 1580 may be tuned to convert the polarization state of the image light 105 to be the second polarization state when respective bulk mirrors 1510 are to propagate the image light 104 through the polarization-selective slanted bulk reflectors 1510. Of course, in an intermediate polarization state of the image light 104, controllable portions 105 of the image light 104 may be out-coupled, and the LC cell(s) 1580 may be tuned to provide the required controllable portion(s) 105 of the image light 104 to be out-coupled from the lightguide body 1502, in accordance with a desired spatial profile of optical power distribution of the image light portions 105.

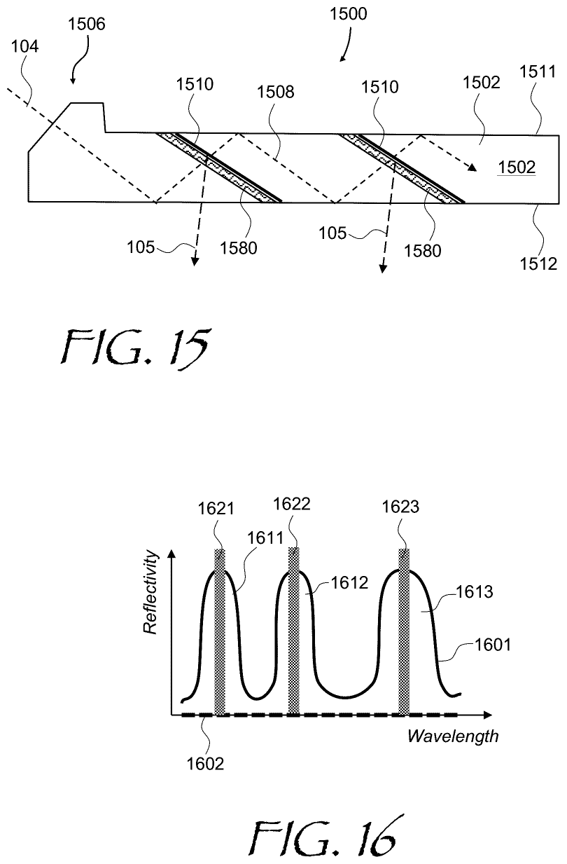

Referring to FIG. 16, an S 1601 and P 1602 reflectivity spectra of an embodiment of slanted bulk reflectors usable in lightguides of this disclosure are presented. The S reflectivity spectrum 1601, i.e. the spectrum for s-polarized image light propagating within the lightguide body, is shown with a solid line. The P reflectivity spectrum 1602, i.e. the spectrum for p-polarized image light propagating within the lightguide body, is shown with a dashed line. The P reflectivity spectrum 1602 is a straight line close to zero reflectivity e.g. <1% reflectivity, or in some embodiments <0.1% reflectivity, while the S reflectivity spectrum 1601 has non-zero reflectivity within first 1611, second 1612, and third 1613 spectral bands, making the slanted bulk reflectors of this embodiment polarization-selective in those spectral bands. Outside of the first 1611, second 1612, and third 1613 spectral bands, the slanted bulk reflectors of this embodiment are substantially transparent, i.e. they substantially (i.e. within 1%) do not reflect the image light propagating within the lightguide body, and they substantially do not reflect the outside light, making the polarization-selective slanted bulk reflectors less conspicuous to an outside viewer.

In some embodiments, the first 1611, second 1612, and third 1613 spectral bands correspond to blue 1621, green 1622, and red 1623 color channels, respectively, of the image light. The bandwidth of the first 1611, second 1612, and third 1613 spectral bands, i.e. the reflection bandwidth of the polarization-selective slanted bulk reflectors, may be reduced to encompass a spectral bandwidth of the blue 1621, green 1622, and red 1623 color channels, respectively, of the image light. In some embodiments, the reflection bandwidth of the polarization-selective slanted bulk reflectors is less than 40 nm, e.g. between 5 nm and 40 nm. Such a configuration can make the polarization-selective slanted bulk reflectors less conspicuous to an external viewer. To provide the spectral bands, the polarization-selective slanted bulk reflectors may include a liquid crystal material.

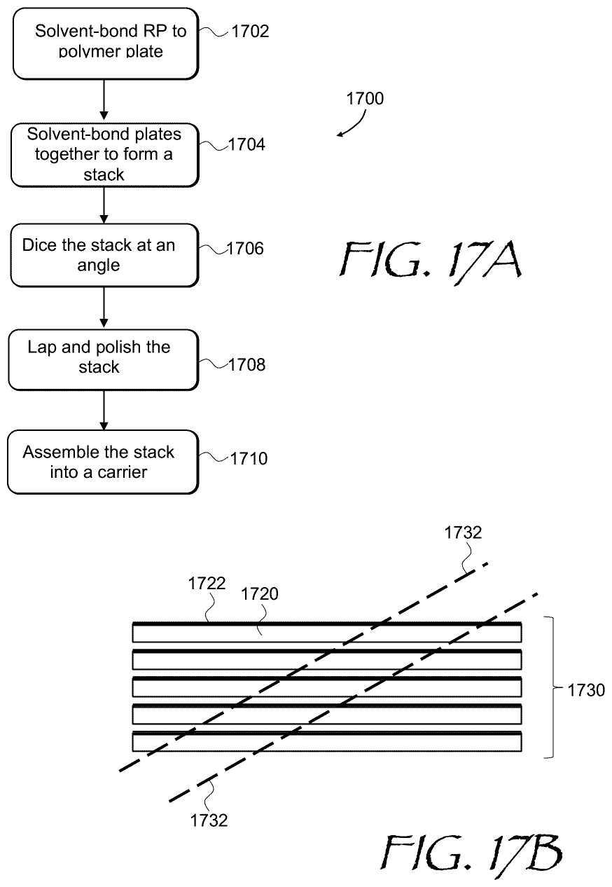

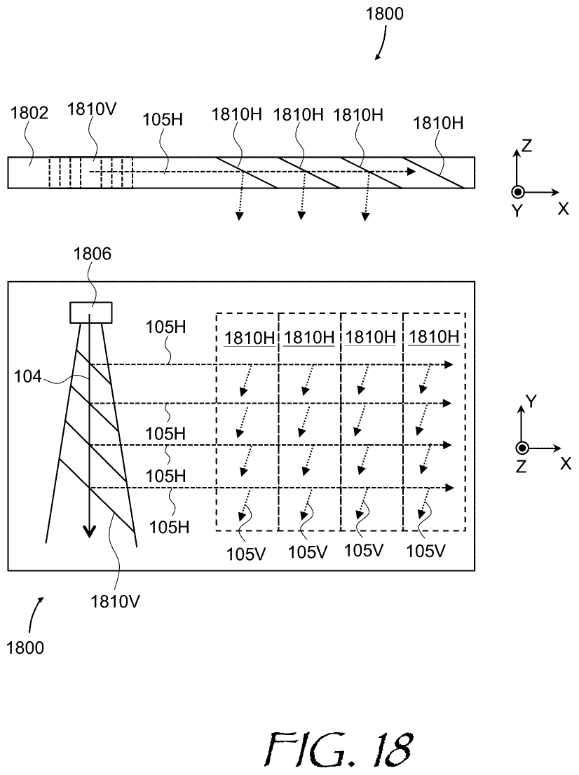

Referring now to FIGS. 17A and 17B, a method 1700 (FIG. 17A) for manufacturing a lightguide of this disclosure for conveying image light in a display device is presented. The method 700 includes obtaining a plurality of polymer plates each having a bonded reflective polarizer, e.g. polymer plates 1720 (FIG. 17B) each having a reflective polarizer 1722 bonded to the corresponding polymer plate 1720. The reflective polarizer may e.g. be solvent-bonded (1702) to a respective polymer plate. The polymer plates may be bonded together (FIG. 17A; 1704) to form a stack 1730.

The stack 1730 may be diced (1706) at an acute angle along thick dashed lines 1732 (FIG. 17B), to obtain a lightguide body comprising an array of polarization-selective slanted bulk reflectors, each polarization-selective slanted bulk reflector comprising one of the polymer plates having one of the reflective polarizers bonded to the plate. The dicing angle is determined by the required slant angle of the polarization-selective bull reflectors within the lightguide. The plurality of polymer plates 1720 may be provided e.g. by bonding a larger polarizer to a larger polymer plate, and dicing the larger polymer plate into the plurality of polymer plates each having the bonded reflective polarizer. The diced stack 1730 may then be processed (1708) to polish the first and second opposed surfaces of the lightguide body. Then, the lightguide body may be assembled (1710) into the lightguide.

Turning to FIG. 18, a pupil-replicating lightguide 1800 may be based on any of the lightguides considered herein. The pupil-replicating lightguide 1800 includes a lightguide body 1802 supporting two arrays of slanted polarization-selective partial bulk reflectors, a vertical array 1810V extending along Y-axis and tilted about Z-axis, and a horizontal array 1810H extending along X-axis and tilted about Y-axis, as shown. In operation, the image light 104 is in-coupled into the lightguide body 1802 by an in-coupler 1806. The horizontal array 1810H expands the image light 104 in vertical dimension, that is, along Y-axis, providing horizontal image light portions 105H. The vertical array 1810V receives the horizontal image light portions 105H and expands the image light in horizontal dimension, that is, along X-axis, providing vertical image light portions 105V. Stress relieving filler or elastic layers may be provided for the slanted polarization-selective partial bulk reflectors of the vertical array 1810V and/or the horizontal array 1810H as explained above with reference to FIGS. 10 and 11. The lightguide body 1802 may be made of a transparent isotropic plastic or polymer material, a glass, an inorganic crystal, etc. By way of non-limiting examples, a difference between ordinary and extraordinary indices of refraction of the plastic or polymer material for the propagating image light may be less than 0.1, or even less than 0.01. An elasticity modulus of the plastic or polymer material may be less than 1 GPa, such as in polydimethylsiloxane (PDMS), for example. These birefringence and elasticity ranges also apply to any other lightguides disclosed herein.

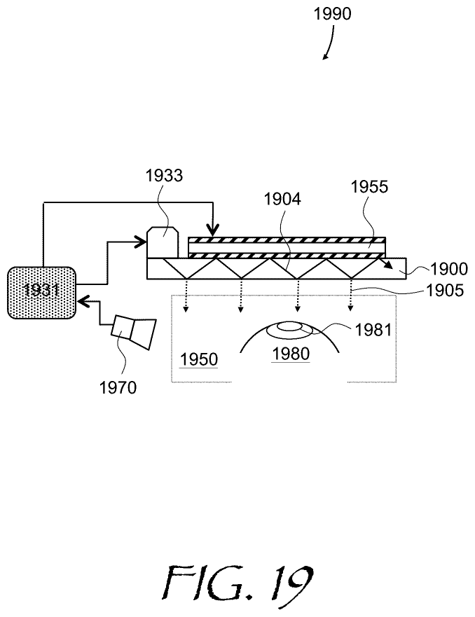

Referring now to FIG. 19 with further reference to FIG. 1A, a display apparatus 1990 includes an image projector 1933 configured to provide image light 1904 carrying an image in an angular domain, and a lightguide 1900 for conveying the image light 1904 carrying an image in angular domain to an eyebox 1950 for viewing by a user's eye 1980. The lightguide 1900 may include, for example, the lightguide 100 of FIGS. 1A-1B, the lightguide 200A of FIG. 2A, the lightguides 400, 500, 600, 700, 800 of FIGS. 4, 5, 6, 7, and 8 respectively, or the lightguides 1100,1300 and 1400 of FIGS. 11, 13, and 14 respectively. The image projector 1933 may be e.g. a scanning image projector including a laser diode coupled to a tiltable reflector such as microelectromechanical system (MEMS) reflector. The image projector 1933 may also be based on a microdisplay panel such as, for example, liquid crystal display or a liquid crystal on silicon (LCoS) display, coupled to a collimator, and/or a micro-LED display. The image projector 1933, also termed herein “light engine”, may include a light source having a spectral bandwidth including red, green, and blue light. In the embodiment shown, the display apparatus 1990 is a near-eye display apparatus providing the image light 104 to the eyebox 1950.

The display apparatus 1990 may further include a polarizing dimmer 1955 for controllably dimming external light by polarization, an eye tracking system 1970 for determining at least one of a location or orientation of the user's eye 1980 in the eyebox 1950, and a controller 1931 operably coupled to the image projector 1933, the polarizing dimmer 1955, and the eye tracking system 1970. For embodiments with controllable optical retarders in the optical path of the image light inside the lightguide 1900, e.g. as explained above with reference to FIG. 15, the controller 1931 may be operably coupled to the controllable optical retarders. In operation, the controller 1931 operates the image projector 1933 to display images or videos to the user's eye 1980, and may attenuate the external light to a level when the external light does not overwhelm the displayed images or videos.

The controller 1931 may be further configured to control the spatial distribution of reflectivities of the slanted polarization-selective reflectors based on information about a current location of the user's eye 1980 in the eyebox 1950 provided by the eye tracking system 1970.

The controller 1931 may be operably coupled to the eye tracking system 1970 for determining an instant position of a pupil 1981 of the eye 1980 in the eyebox 1950 of the display apparatus 1990 based on the determined position and orientation of the eye 1980. The eye tracking system 1970 may update the information about the position of the pupil 1981 of the user's eye 1980 in real time. The controller 1931 may be configured to control the optical retarders based on the information received from the eye tracking system 1970, and/or based on the current FOV portion displayed by the image projector 1933. The controller 1931 may be configured to increase those of the image light portions 1905 that are directed at the eye pupil 1981, while attenuating image light portions 1905 that are missing the eye pupil 1981 to preserve power by better utilizing the image light 1904. By redistributing the image light portions 1905 to mostly propagate towards the eye pupil 1981, the controller 1931 increases the optical power level of the image light 1904 that reaches the eye pupil 1981, thereby considerably improving wall plug efficiency of the display apparatus 1990.

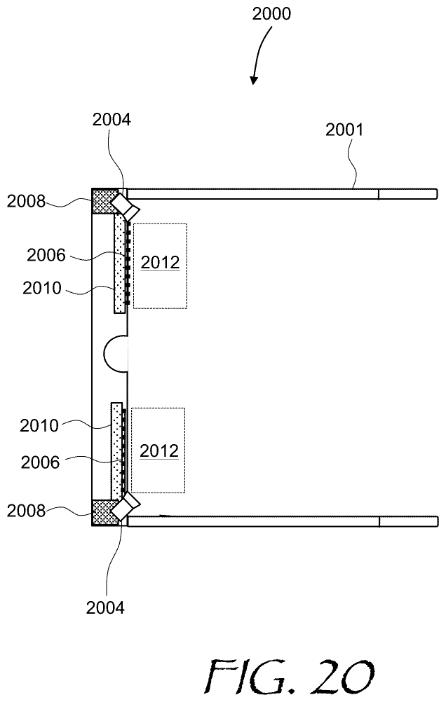

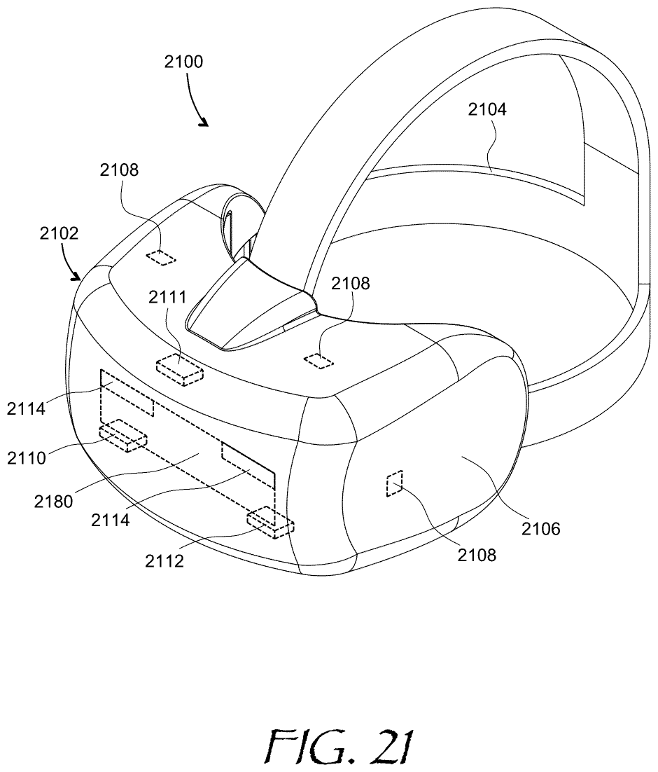

Referring to FIG. 20, an augmented reality (AR) near-eye display 2000 is an embodiment of the display apparatus 1990 of FIG. 19. The AR near-eye display 2000 of FIG. 20 includes a frame 2001 supporting, for each eye: a light engine or image projector 2008 for providing an image light beam carrying an image in angular domain, a pupil-replicating lightguide 2010 based on any of the lightguides disclosed herein, for providing multiple offset portions of the image light beam to spread the image in angular domain across an eyebox 2012, and a plurality of eyebox illuminators 2006, shown as black dots, spread around a clear aperture of the pupil-replicating lightguide 2010 on a surface that faces the eyebox 2012. An eye-tracking camera 2004 may be provided for each eyebox 2012.

The purpose of the eye-tracking cameras 2004 is to determine position and/or orientation of both eyes of the user. The eyebox illuminators 2006 illuminate the eyes at the corresponding eyeboxes 2012, allowing the eye-tracking cameras 2004 to obtain the images of the eyes, as well as to provide reference reflections i.e. glints. The glints may function as reference points in the captured eye image, facilitating the eye gazing direction determination by determining position of the eye pupil images relative to the glint positions. To avoid distracting the user with the light of the eyebox illuminators 2006, the latter may be made to emit light invisible to the user. For example, infrared light may be used to illuminate the eyeboxes 2012.

Turning to FIG. 21, an HMD 2100 is an example of an AR/VR wearable display system which encloses the user's face, for a greater degree of immersion into the AR/VR environment. The HMD 2100 may generate the entirely virtual 3D imagery. The HMD 2100 may include a front body 2102 and a band 2104 that can be secured around the user's head. The front body 2102 is configured for placement in front of eyes of a user in a reliable and comfortable manner. A display system 2180 may be disposed in the front body 2102 for presenting AR/VR imagery to the user. The display system 2180 may include any of the display devices and illuminators disclosed herein. Sides 2106 of the front body 2102 may be opaque or transparent.

In some embodiments, the front body 2102 includes locators 2108 and an inertial measurement unit (IMU) 2110 for tracking acceleration of the HMD 2100, and position sensors 2112 for tracking position of the HMD 2100. The IMU 2110 is an electronic device that generates data indicating a position of the HMD 2100 based on measurement signals received from one or more of position sensors 2112, which generate one or more measurement signals in response to motion of the HMD 2100. Examples of position sensors 2112 include: one or more accelerometers, one or more gyroscopes, one or more magnetometers, another suitable type of sensor that detects motion, a type of sensor used for error correction of the IMU 2110, or some combination thereof. The position sensors 2112 may be located external to the IMU 2110, internal to the IMU 2110, or some combination thereof.

The locators 2108 are traced by an external imaging device of a virtual reality system, such that the virtual reality system can track the location and orientation of the entire HMD 2100. Information generated by the IMU 2110 and the position sensors 2112 may be compared with the position and orientation obtained by tracking the locators 2108, for improved tracking accuracy of position and orientation of the HMD 2100. Accurate position and orientation is important for presenting appropriate virtual scenery to the user as the latter moves and turns in 3D space.

The HMD 2100 may further include a depth camera assembly (DCA) 2111, which captures data describing depth information of a local area surrounding some or all of the HMD 2100. The depth information may be compared with the information from the IMU 2110, for better accuracy of determination of position and orientation of the HMD 2100 in 3D space.

The HMD 2100 may further include an eye tracking system 2114 for determining orientation and position of user's eyes in real time. The obtained position and orientation of the eyes also allows the HMD 2100 to determine the gaze direction of the user and to adjust the image generated by the display system 2180 accordingly. The determined gaze direction and vergence angle may be used to adjust the display system 2180 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 2102.

Non-limiting illustrative examples of lightguides and devices of this disclosure are provided below.

Example 1. A lightguide for conveying image light in a display device, the lightguide comprising:
a lightguide body comprising first and second opposed surfaces running parallel to each other for propagating the image light within the lightguide body along a zigzag light path defined by alternating reflections of the image light from the first and second surfaces; and
an array of polarization-selective slanted bulk reflectors along the zigzag light path within the lightguide body for out-coupling light in a first polarization state while transmitting therethrough light in a second, orthogonal polarization state, whereby in operation, laterally offset polarized portions of the image light are out-coupled from the lightguide body towards an eyebox of the display device.

Example 2. The lightguide of Example 1, wherein the polarization-selective slanted bulk reflectors of the array comprise at least one of: a dielectric layer stack; helicoidal cholesteric liquid crystals; or ferroelectric nematic liquid crystals.

Example 3. The lightguide of Example 1, wherein the polarization-selective slanted bulk reflectors are configured to lessen a reflection of outside light therefrom when the outside light impinges onto the first surface of the lightguide body at a normal angle of incidence.

Example 4. The lightguide of Example 1, wherein polarization-selective slanted bulk reflectors of the array each comprise a wiregrid polarizer.

Example 5. The lightguide of Example 1, wherein the lightguide body comprises:
a first lightguide body portion comprising the first surface of the lightguide body on one side and a first ridged surface on an opposite side, the first ridged surface comprising a first plurality of slanted facets; and
a second lightguide body portion comprising the second surface of the lightguide body on one side and a second ridged surface on an opposite side, the second ridged surface comprising a second plurality of slanted facets, wherein:

the first and second lightguide body portions match one another when put together; and/or
polarization-selective slanted bulk reflectors of the array of polarization-selective slanted bulk reflectors are sandwiched between corresponding slanted facets of the first and second pluralities of slanted facets of the first and second lightguide body portions respectively.

Example 6. The lightguide of Example 5, further comprising:
a first bonding layer between polarization-selective bulk reflectors of the array and slanted facets of the first plurality of slanted facets; and
a second bonding layer between polarization-selective bulk reflectors of the array and slanted facets of the second plurality of slanted facets.

Example 7. The lightguide of Example 6, wherein:
at least one of the first or second bonding layers comprises at least one of an adhesive layer or a polymer layer; and/or
wherein at least one of the first or second bonding layers has a modulus of elasticity of between 0.1 GPa and 10 GPa; or in some embodiments, between 0.5 GPa and 5 GPa.

Example 8. The lightguide of Example 1, wherein polarization-selective slanted bulk reflectors of the array each comprise:
a polarization-selective reflector layer; and
a pair of stress-imparting layers on opposite sides of the polarization-selective reflector layer, for imparting compressive stress thereto.

Example 9. The lightguide of Example 8, wherein:
the stress-imparting layers have a coefficient of thermal expansion higher than that of the polarization-selective reflector layer; and/or
the stress-imparting layers are hot laminated onto the polarization-selective reflector layer.

Example 10. The lightguide of Example 1, wherein the first and second surfaces are parallel to one another to within 0.1 degree or better, and/or the first and second surfaces have roughness of less than 8 nm peak-to-peak.

Example 11. The lightguide of Example 1, wherein the lightguide body comprises isotropic material having a refractive index of between 1.45 and 1.85.

Example 12. The lightguide of Example 1, wherein the first and second surfaces of the lightguide body form a meniscus shape.

Example 13. The lightguide of Example 12, wherein the meniscus shape follows a simple curve or a complex curve in a cross-section comprising one of length or width dimensions and a thickness dimension of the lightguide body.

Example 14. The lightguide of Example 1, further comprising an array of optical retarders along the zigzag light path within the lightguide body for changing a polarization state of the image light propagating along the zigzag light path.

Example 15. The lightguide of Example 14, wherein optical retarders of the array of optical retarders are tunable by application of an external signal.

Example 16. The lightguide of Example 14, wherein optical retarders of the array of optical retarders comprise liquid crystals.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A lightguide for conveying image light in a display device, the lightguide comprising:
a lightguide body comprising first and second opposed surfaces running parallel to each other for propagating the image light within the lightguide body along a zigzag light path defined by alternating reflections of the image light from the first and second surfaces; and
an array of polarization-selective slanted bulk reflectors along the zigzag light path within the lightguide body for out-coupling light in a first polarization state while transmitting therethrough light in a second, orthogonal polarization state, whereby in operation, laterally offset polarized portions of the image light are out-coupled from the lightguide body towards an eyebox of the display device.

2. The lightguide of claim 1, wherein polarization-selective slanted bulk reflectors of the array each comprise a multilayer birefringent polymer film.

3. The lightguide of claim 1, wherein a spectral bandwidth of the polarization-selective slanted bulk reflectors is tunable by applying at least one of an electric or magnetic field, whereby optical transmission of outside light through the polarization-selective slanted bulk reflectors is variable.

4. The lightguide of claim 3, wherein the polarization-selective slanted bulk reflectors comprise at least one of helicoidal cholesteric liquid crystals or ferroelectric nematic liquid crystals.

5. The lightguide of claim 1, wherein the polarization-selective slanted bulk reflectors have a reflection bandwidth of less than 40 nm for a color channel of the image light propagating within the lightguide body.

6. The lightguide of claim 1, wherein the polarization-selective slanted bulk reflectors are configured to lessen a reflection of outside light therefrom when the outside light impinges onto the lightguide body at an angle of incidence of less than 70 degrees.

7. The lightguide of claim 1, wherein polarization-selective slanted bulk reflectors of the array have a reflectivity range for the image light of between 4% and 80% for a first polarization, and less than 1% for a second, orthogonal polarization.

8. The lightguide of claim 1, wherein polarization-selective slanted bulk reflectors of the array have a refractive index of greater than 1.65.

9. The lightguide of claim 1, further comprising elastic layers between polarization-selective bulk reflectors of the array and the lightguide body.

10. The lightguide of claim 1, wherein the lightguide body comprises:
a first lightguide body portion comprising the first surface of the lightguide body on one side and a first ridged surface on an opposite side, the first ridged surface comprising a first plurality of slanted facets; and
a second lightguide body portion comprising the second surface of the lightguide body on one side and a second ridged surface on an opposite side, the second ridged surface comprising a second plurality of slanted facets, wherein:
the first and second lightguide body portions match one another when put together; and
polarization-selective slanted bulk reflectors of the array of polarization-selective slanted bulk reflectors are sandwiched between corresponding slanted facets of the first and second pluralities of slanted facets of the first and second lightguide body portions respectively.

11. The lightguide of claim 10, further comprising:
a first bonding layer between polarization-selective bulk reflectors of the array and slanted facets of the first plurality of slanted facets; and
a second bonding layer between polarization-selective bulk reflectors of the array and slanted facets of the second plurality of slanted facets.

12. The lightguide of claim 1, wherein the lightguide body comprises a polymer material preserving a polarization state of the image light propagating therein.

13. The lightguide of claim 12, wherein the polymer material has a difference between ordinary and extraordinary indices of refraction for the propagating image light of less than 0.1.

14. The lightguide of claim 12, wherein the polymer material has an elasticity modulus of less than 1 GPa.

15. The lightguide of claim 1, wherein the lightguide body comprises a polarizer for polarizing the image light propagating along the zigzag light path to have the first polarization state.

16. A method for manufacturing a lightguide for conveying image light in a display device, the method comprising:
obtaining a plurality of polymer plates each having a reflective polarizer bonded thereto;
bonding the polymer plates together, to form a stack; and
dicing the stack at an acute angle, to obtain a lightguide body comprising an array of polarization-selective slanted bulk reflectors, each polarization-selective slanted bulk reflector comprising one of the polymer plates having one of the reflective polarizers bonded thereto.

17. The method of claim 16, further comprising polishing first and second opposed surfaces of the lightguide body, and assembling the lightguide body into the lightguide.

18. A display apparatus comprising:
a light engine for providing image light carrying an image in angular domain; and
a lightguide for expanding the image light over an eyebox of the display apparatus, the lightguide comprising:
a lightguide body comprising first and second opposed surfaces running parallel to each other for propagating the image light within the lightguide body along a zigzag light path defined by alternating reflections of the image light from the first and second surfaces; and
an array of polarization-selective slanted bulk reflectors along the zigzag light path within the lightguide body for out-coupling light in a first polarization state while transmitting therethrough light in a second, orthogonal polarization state, whereby in operation, laterally offset polarized portions of the image light are out-coupled from the lightguide body towards an eyebox of the display device.

19. The display apparatus of claim 18, further comprising a transmissive polarizer coupled to the first surface of the lightguide body for polarizing impinging external light to have the second polarization state.

20. The display apparatus of claim 18, wherein the light engine is configured for emitting the polarized light and comprises at least one of a liquid crystal display, a micro-LED display, a liquid crystal on silicon (LCoS) display, or a laser diode coupled to a tiltable reflector.
